(19) United States
(12) Patent Application Publication
(10) Pub. No.: US 2006/0149877 A1
(43) Pub. Date: Jul. 6, 2006

(54) Interrupt management for digital media processor

(76) Inventor: Adrian R. Pearson, Phoenix, AZ (US)

Correspondence Address: BUCKLEY, MASCHOFF, TALWALKAR LLC, 5 ELM STREET, NEW CANAAN, CT, 06840, US

(21) Appl. No.: 11/028,405

(22) Filed: Jan. 3, 2005

(51) Int. Cl. G06F 13/24

(52) U.S. Cl. 710/260

(57) ABSTRACT

A method includes receiving a first interrupt from a digital media processor and blocking execution of an application program while the first interrupt is being handled. The method further includes receiving a second interrupt from the digital media processor and allowing execution of the application program to continue while the second interrupt is being handled.

### BACKGROUND

Digital media processors are typically used for image-processing applications in electronic devices such as copiers, scanners, etc. In a typical configuration a digital media processor is controlled by a host processor which provides over-all control functions for the electronic device. The software which programs the host processor may include one or more modules to control the digital media processor. One issue that may need to be addressed by such modules is how to handle interrupt events (“interrupts”) initiated by the digital media processor or components of the digital media processor.

### BRIEF DESCRIPTION OF THE DRAWINGS

FIG. 1 is a block diagram that illustrates aspects of a system provided in accordance with some embodiments.

FIG. 2 is a diagram which illustrates a software stack for managing a digital media processor that is part of the system of FIG. 1.

FIG. 3 is a flow chart that illustrates a process that may be implemented by a hardware abstraction layer of the software stack of FIG. 2.

FIGS. 4A-4B illustrate aspects of interrupt handling by the software stack of FIG. 2.

### DETAILED DESCRIPTION

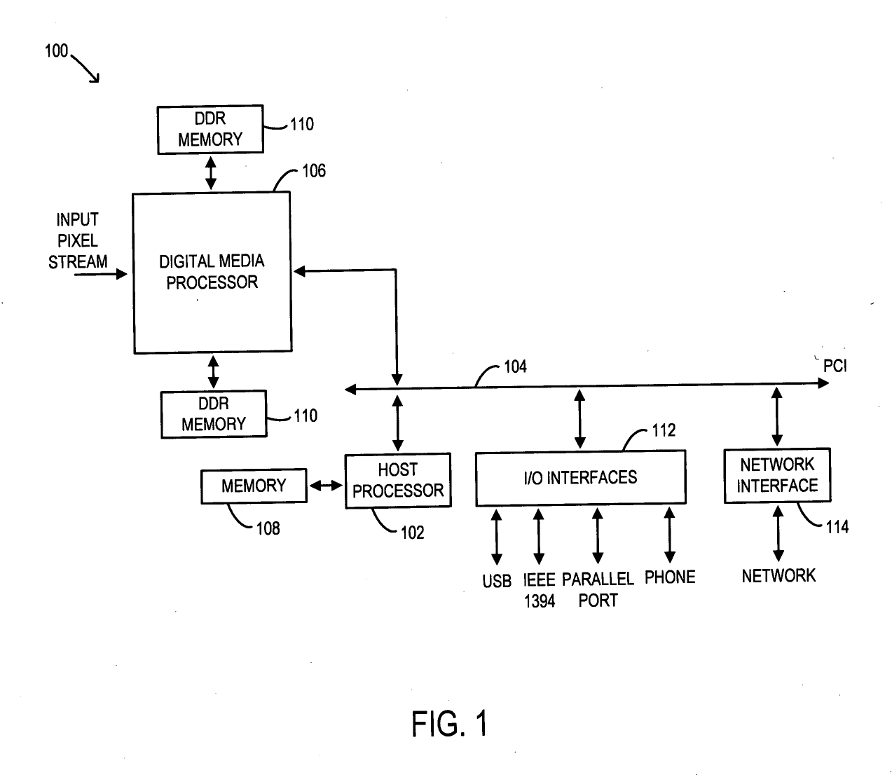

FIG. 1 is a block diagram that illustrates aspects of a system 100 provided in accordance with some embodiments. The system 100 may be, for example, a copier or scanner or the like. (To simplify the drawing, a number of components such as optical systems, mechanical components, print mechanisms, etc. are omitted from the drawing.)

The system 100 includes a host processor 102, which may for example be a conventional microprocessor. The system 100 may also include a bus 104 (e.g., a PCI bus) to which the host processor 102 is coupled. In addition, the system 100 may include a digital media processor 106 which may be coupled to the host processor 102 via the bus 104. In some embodiments, the digital media processor 106 may be the model MXP5800 digital media processor available from Intel Corporation, the assignee hereof.

The system 100 may further include a memory 108 coupled to the host processor 102 to serve as program storage, working memory, etc. Still further, the system 100 may include one or more double data rate (DDR) memories 110 coupled to the digital media processor 106 to serve as working memory and/or to receive input image data and/or processed image data from the digital media processor 106. In addition the system 100 may include various input/output interfaces 112 coupled to the host processor 102 via the bus 104 and a network interface 114 coupled to the host processor 102 via the bus 104.

The architecture of the digital media processor may provide for highly parallel processing and may comprise a relatively large number of components, each of which is able to initiate interrupts. For example, the above-mentioned MXP5800 digital media processor includes eight mesh-connected image signal processors (ISPs), and each ISP includes eight processing elements, each of which may initiate an interrupt. Further, the MXP5800 includes direct memory access (DMA) units which comprise in total 32 DMA engines, each of which may initiate an interrupt. In addition, the MXP5800 includes a PCI error interrupt unit which may initiate an interrupt. Thus the MXP5800 may generate potentially 97 unique interrupts.

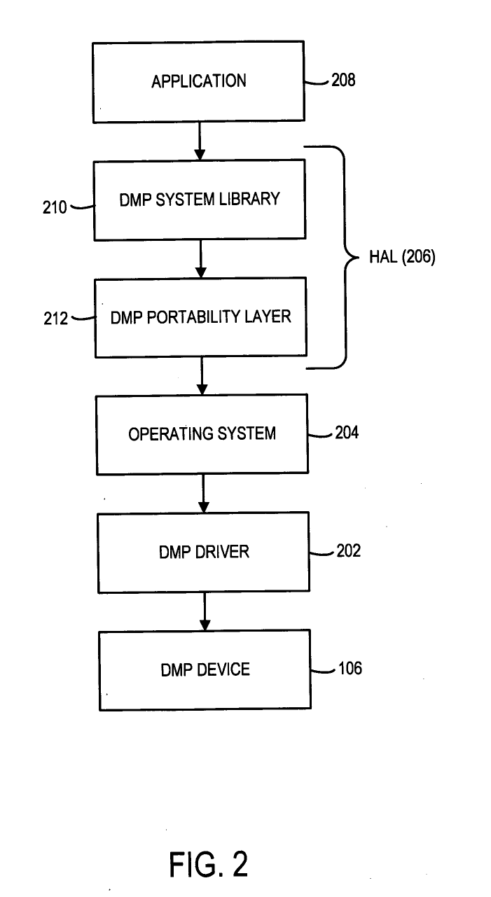

FIG. 2 is a diagram which illustrates a software stack for managing the digital media processor 106. The software components illustrated in FIG. 2 execute on the host processor 102 and enable the host processor 102 to manage the digital media processor 106.

Direct communication with the digital media processor 106 is via a device driver software component 202. In turn, communication with the device driver software component 202 is via the operating system 204, which may be a conventional operating system (OS) such as Windows or Linux. A hardware abstraction layer (HAL) 206 mediates between the system application program 208 and the OS 204 in regard to interactions with the digital media processor 106. The HAL 206 is an application program interface (API) between the application program 208 and the device driver 202 and aids in promoting rapid development of the application program and portability of the application program to other operating systems and/or other generations of the digital media processor. Portability of the HAL 206 itself to other operating systems is enhanced by dividing the HAL 206 between a system library 210 and a portability layer 212. The HAL system library 210 may provide to the application program 208 a set of intuitive, easy to use function calls specific to the components of the digital media processor 106. The HAL portability layer 212 contains low level function calls that would need to be modified to port the system library 210 to a different operating system or to different host processor hardware. The function calls of the portability layer 212 may be called by higher level functions included in the system library 210.

Management of interrupts from components of the digital media processor 106 is among the functions performed by the HAL 206. In some embodiments, the HAL 206 provides flexibility to the designer of the application program by supporting two types of interrupt handling mechanisms. According to a first type of interrupt handling, hereinafter referred to as the “asynchronous interrupt manager”, a processing thread responds to an interrupt event by calling a callback function that proceeds contemporaneously with the processing thread that executes the application program. Thus the asynchronous interrupt manager allows execution of the application program to continue while the asynchronous interrupt manager handles the interrupt. According to a second type of interrupt handling, hereinafter referred to as the “synchronous interrupt manager”, the thread by which the application is executed is blocked during handling of the interrupt by the thread in which the synchronous interrupt manager executes. With both of these capabilities present in the HAL 206, the designer of the application program may select which type of interrupt manager is to respond to each of the various interrupts that may be initiated by components of the digital media processor. Thus the designer of the application program is given greater flexibility in interrupt handling than if only one of the two interrupt managers were supported.

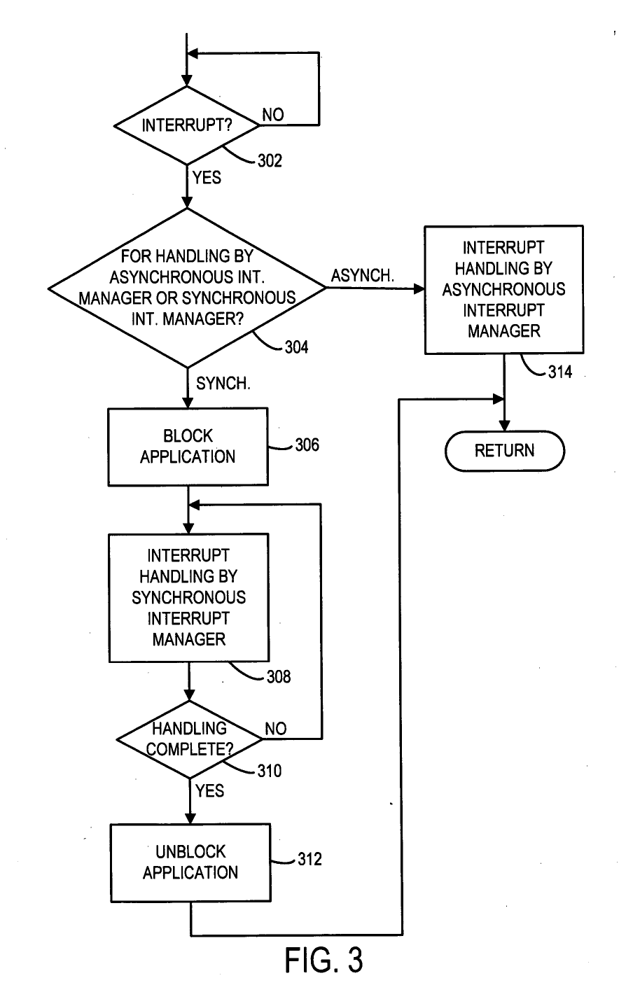

FIG. 3 is a flow chart that illustrates a process that may be implemented by the hardware abstraction layer 206.

At 302 in FIG. 3, it is determined whether an interrupt event is received. If so, it is next determined, at block 304, whether the interrupt event is to be handled by the asynchronous interrupt manager or by the synchronous interrupt manager.

If it is determined that the interrupt is to be handled by the synchronous interrupt manager, then further execution of the application program thread is blocked, as indicated at 306, and the interrupt is handled by the synchronous interrupt manager, as indicated at 308. As indicated by decision block 310, once the handling of the interrupt by the synchronous interrupt manager is complete, the application program thread is unblocked (312 in FIG. 3).

If it is determined at 304 that the interrupt is to be handled by the asynchronous interrupt manager, then as indicated at 314, handling of the interrupt by the asynchronous interrupt manager proceeds, without the application thread being blocked.

Thus, over time, a first interrupt may be handled by the synchronous interrupt manager, and execution of the application may be blocked while the first interrupt is being handled. Thereafter or previously, a second interrupt may be handled by the asynchronous interrupt handler, with the second interrupt being handled in one processing thread while execution of the application continues in another processing thread.

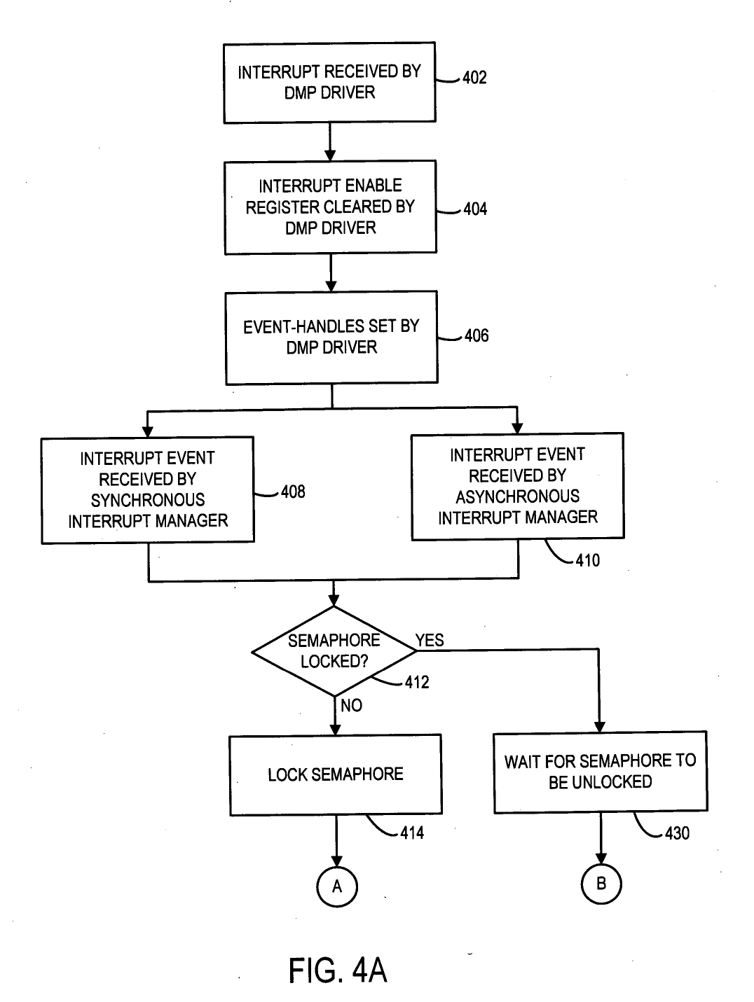

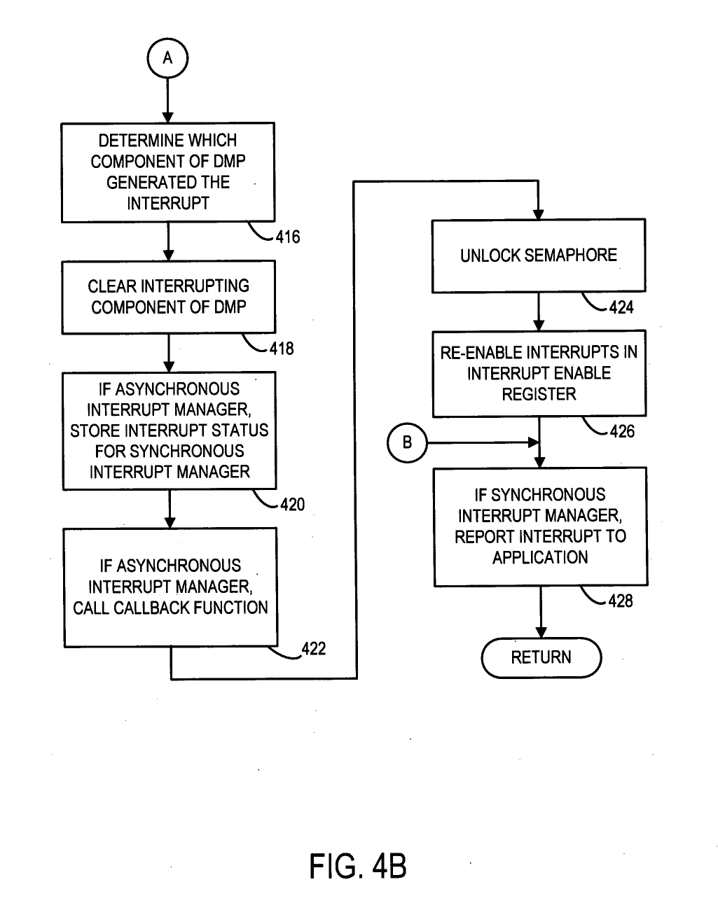

FIGS. 4A-4B illustrate aspects of interrupt handling that the synchronous and asynchronous interrupt managers may have in common. Also illustrated in FIGS. 4A and 4B are certain functions performed by the digital media processor device driver software component 202 (FIG. 2) prior to invoking the synchronous or asynchronous interrupt manager, as the case may be.

At 402 in FIG. 4A, the device driver receives an interrupt. At 404 the device driver clears an interrupt enable register (not separately shown). Then at 406, the device driver sets event-handles.

At this point in the process, depending on the nature of the interrupt event that has been received, either the interrupt event is received by the synchronous interrupt manager, as indicated at 408, or the interrupt event is received by the asynchronous interrupt manager, as indicated at 410. In any case, the interrupt manager that receives the interrupt event then determines, as indicated at 412, whether a semaphore is in a “locked” condition. As used herein and in the appended claims, a “semaphore” is a flag which indicates to a processing thread whether the processing thread may proceed.

If it is determined at 412 that the semaphore is not in a locked condition, then the interrupt manager in question places the semaphore in the locked condition (414 in FIG. 4A) in order to block processing by the other interrupt manager until the current interrupt has been handled.

Then, as indicated at 416 (FIG. 4B), the interrupt manager in question determines which component of the digital media processor generated the current interrupt. At 418, the interrupt manager in question clears the component which was determined at 416 to have generated the interrupt. At 420, if the interrupt manager in question is the asynchronous interrupt manager, the asynchronous interrupt manager stores the current interrupt status for subsequent use by the synchronous interrupt manager. Also, as indicated at 422, if the interrupt manager in question is the asynchronous interrupt manager, the asynchronous interrupt manager calls the particular callback function associated with the interrupt that is being handled.

Next, and regardless of whether the interrupt manager currently operating is the synchronous or asynchronous interrupt manager, at 424 the semaphore is returned to an unlocked condition and at 426 the interrupt manager in question re-enables interrupts in the interrupt enable register. Then, at 428, if the interrupt manager in question is the synchronous interrupt manager, the synchronous interrupt manager reports the interrupt to the application program.

Considering again decision block 412 (FIG. 4A), if it is determined at that point that the semaphore is in a locked condition, then, as indicated at 430, the interrupt manager in question waits for the semaphore to be unlocked. Once the semaphore is unlocked, stage 428 (FIG. 4B) follows stage 430.

As used herein and in the appended claims, “digital media processor” refers to a processor that is optimized to perform image signal processing.

In embodiments discussed above, one digital media processor is included in the system 100. In other embodiments, two or more digital media processors may be included in the system and may be controlled via the software stack described above with reference to FIGS. 2-4B.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

What is claimed is:

1. A method comprising:
receiving a first interrupt from a digital media processor;
blocking execution of an application program while the first interrupt is being handled;
receiving a second interrupt from the digital media processor; and
allowing execution of the application program to continue while the second interrupt is being handled.

2. The method of claim 1, further comprising:
unblocking execution of the application program upon completion of handling of the first interrupt.

3. The method of claim 1, wherein the second interrupt is handled in a first processing thread while execution of the application program continues in a second processing thread.

4. The method of claim 1, wherein handling of the first interrupt includes:
locking a semaphore;
determining which component of the digital media processor generated the first interrupt;
clearing the determined component;
unlocking the semaphore;
re-enabling interrupts in an interrupt register; and
reporting the first interrupt to the application program.

5. The method of claim 4, wherein handling the second interrupt includes:
locking the semaphore;
determining which component of the digital media processor generated the second interrupt;
clearing the component which generated the second interrupt;
storing an interrupt status for a synchronous interrupt manager;
calling a callback function associated with the second interrupt;
unlocking the semaphore; and
re-enabling interrupts in the interrupt register.

6. The method of claim 1, wherein handling the second interrupt includes:
locking a semaphore;
determining which component of the digital media processor generated the second interrupt;
clearing the determined component;
storing interrupt status for a synchronous interrupt manager;
calling a callback function associated with the second interrupt;
unlocking the semaphore; and
re-enabling interrupts in an interrupt register.

7. A system comprising:
a host processor;
a memory in communication with the host processor; and
the host processor operative with a program stored in the memory to:
receive a first interrupt from a digital media processor;
block execution of an application program while the first interrupt is being handled;
receive a second interrupt from the digital media processor; and
allow execution of the application program to continue while the second interrupt is being handled.

8. The system of claim 7, wherein the processor is further operative to:
unblock execution of the application program upon completion of handling of the first interrupt.

9. The system of claim 7, wherein the second interrupt is handled in a first processing thread while execution of the application program continues in a second processing thread.

10. The system of claim 7, wherein handling of the first interrupt includes:
locking a semaphore;
determining which component of the digital media processor generated the first interrupt;
clearing the determined component;
unlocking the semaphore;
re-enabling interrupts in an interrupt register; and
reporting the first interrupt to the application program.

11. The system of claim 10, wherein handling the second interrupt includes:
locking the semaphore;
determining which component of the digital media processor generated the second interrupt;
clearing the component which generated the second interrupt;
storing an interrupt status for a synchronous interrupt manager;
calling a callback function associated with the second interrupt;
unlocking the semaphore; and
re-enabling interrupts in the interrupt register.

12. The system of claim 7, wherein handling the second interrupt includes:
locking a semaphore;
determining which component of the digital media processor generated the second interrupt;
clearing the determined component;
storing an interrupt status for a synchronous interrupt manager;
calling a callback function associated with the second interrupt;
unlocking the semaphore; and
re-enabling interrupts in an interrupt register.

13. An apparatus comprising:
a storage medium having stored thereon instructions that when executed by a machine result in the following:
receiving a first interrupt from a digital media processor;
blocking execution of an application program while the first interrupt is being handled;
receiving a second interrupt from the digital media processor; and
allowing execution of the application program to continue while the second interrupt is being handled.

14. The apparatus of claim 13, wherein the instructions when executed by the machine further result in:
unblocking execution of the application program upon completion of handling of the first interrupt.

15. The apparatus of claim 13, wherein the second interrupt is handled in a first processing thread while execution of the application program continues in a second processing thread.

16. The apparatus of claim 13, wherein handling of the first interrupt includes:
locking a semaphore;
determining which component of the digital media processor generated the first interrupt;
clearing the determined component;
unlocking the semaphore;
re-enabling interrupts in an interrupt register; and
reporting the first interrupt to the application program.

17. The apparatus of claim 16, wherein handling the second interrupt includes:
locking the semaphore;
determining which component of the digital media processor generated the second interrupt;
clearing the component which generated the second interrupt;
storing an interrupt status for a synchronous interrupt manager;
calling a callback function associated with the second interrupt;
unlocking the semaphore; and
re-enabling interrupts in the interrupt register.

18. The apparatus of claim 13, wherein handling the second interrupt includes:
locking a semaphore;
determining which component of the digital media processor generated the second interrupt;
clearing the determined component;
storing an interrupt status for a synchronous interrupt manager;
calling a callback function associated with the second interrupt;
unlocking the semaphore; and
re-enabling interrupts in an interrupt register.
